(19) United States
(12) Patent Application Publication
(10) Pub. No.: US 2025/0124714 A1
(43) Pub. Date: Apr. 17, 2025

(54) METHOD AND SYSTEM FOR ADAPTIVE IDENTIFICATION OF SUSPICIOUS ACTIVITIES

(71) Applicant: AMARJOT SINGH, Bethel, CT (US)

(72) Inventor: AMARJOT SINGH, Bethel, CT (US)

(73) Assignee: AMARJOT SINGH, (US)

(21) Appl. No.: 19/002,815

(22) Filed: Dec. 27, 2024

Related U.S. Application Data
(63) Continuation-in-part of application No. 16/895,515, filed on Jun. 8, 2020.

(51) Int. Cl. G06V 20/52; G06V 10/75; G06V 10/764; G06V 10/766; G06V 10/77; G06V 10/778; G06V 10/82; G06V 40/10; G06V 40/20

(52) U.S. Cl. CPC G06V 20/52; G06V 10/751; G06V 10/764; G06V 10/7715; G06V 10/778; G06V 10/82; G06V 40/10; G06V 40/20; G06V 10/766

(57) ABSTRACT

This disclosure relates to method and system for adaptive identification of suspicious activities. The method includes receiving image data captured by an image capturing device. For each of the plurality of frames, the method includes processing the frame. Processing the frame includes detecting, via a deep learning network, one or more individuals in the frame, and estimating, through the deep learning network, a pose of each individual and determining, via the deep learning network, behaviour dynamics of the one or more individuals based on the pose estimated in each of the plurality of frames. The method further includes classifying, via a 3D ResNet, the behaviour dynamics as one of suspicious and non-suspicious.

### CROSS-REFERENCE TO RELATED APPLICATION

This application claims the benefit of and is a continuation-in-part of pending U.S. application Ser. No. 16/895,515 filed on Jun. 8, 2020, which are hereby expressly incorporated by reference in its entirety for all purposes.

### TECHNICAL FIELD

This disclosure relates generally to surveillance, and more particularly to method and system for adaptive identification of suspicious activities.

### BACKGROUND

In recent years, the rate of criminal activities and related events carried out by individuals and terrorist groups has been on the rise. Economic and social life has suffered due to these criminal activities and related events. As a result, public safety and security has become a major priority. In order to monitor and curb such threats, law enforcement agencies are increasingly relying on video based safety and security systems.

To this end, many automated video based safety systems have been developed to monitor abandoned objects (bags), theft, fire or smoke, or violent activities, etc. The conventional systems, however, can monitor limited areas due to restricted field of view of the cameras. Thus, the law enforcement agencies have been motivated to use aerial surveillance systems in order to bring large areas under contant surveillance. For example, drones have been deployed in war zones to monitor hostiles, to spy on foreign drug cartels, conducting border control operations as well as detecting criminal activity in urban and rural areas. The drones deployed record videos and capture images for surveillance of activities happending on the ground. However, the images or videos recorded by the drones may suffer from illumination changes, shadows, poor resolution, and blurring. Thus, it becomes extremely challenging to decipher correct information from these videos and images. For example, people may appear at different locations, orientations, and scales. Because of the aforementioned issues in the conventional techniques, violent activities may be detected with accuracy levels that are far lower than accuracy levels required to take a decisive action. Moreover, these conventional techniques are not able to accurately identify individuals involved in carrying objects of interest or weapons and engaging in supicious or criminal activities within crowded spaces.

Thus, the present invention is directed to overcome one or more limitations stated above or any other limitations associated with the known arts and enable more robust and accurate real-time threat and suspicious individual detection capabilities.

### SUMMARY

In one embodiment, a method for adaptive identification of suspicious activities is disclosed. In one example, the method may include receiving image data captured by an image capturing device. The image data may include a plurality of frames. For each frame of the plurality of frames, the method may further include processing the frame. Processing the frame may include detecting, via a deep learning network, one or more individuals in the frame. Processing the frames may further include estimating, through the deep learning network, a pose of each of the one or more individuals. The method may further include determining, via the deep learning network, behavior dynamics of the one or more individuals based on the pose estimated in each of the plurality of frames. The behavior dynamics may include at least one of interaction patterns amongst the one or more individuals and an activity pattern of each of the one or more individuals. The method may further include classifying, via a 3-dimensional (3D) Residual Network (ResNet), the behavior dynamics as one of suspicious and non-suspicious. The behaviour dynamics classified as suspicious may be one of pre-trained suspicious behaviour dynamics or new suspicious behaviour dynamics. The method may further include performing, by the 3D ResNet, incremental learning based on the new suspicious behavior dynamics.

In another embodiment, a system for adaptive identification of suspicious activities is disclosed. In one example, the system may include a processor and a computer-readable medium communicatively coupled to the processor. The computer-readable medium may store processor-executable instructions, which, on execution, may cause the processor to receive image data captured by an image capturing device. The image data includes a plurality of frames. For each frame of the plurality of frames, the processor-executable instructions, on execution, may further cause the processor to process the frame. To process the frame, the processor-executable instructions, on execution, may further cause the processor to detect, via a deep learning network, one or more individuals in the frame. To process the frame, the processor-executable instructions, on execution, may further cause the processor to estimate, through the deep learning network, a pose of each of the one or more individuals. The processor-executable instructions, on execution, may further cause the processor to determine, via the deep learning network, behavior dynamics of the one or more individuals based on the pose estimated in each of the plurality of frames. The behavior dynamics may include at least one of interaction patterns amongst the one or more individuals and one of an activity pattern of each of the one or more individuals. The processor-executable instructions, on execution, may further cause the processor to classify, via a 3D ResNet, the behavior dynamics as one of suspicious and non-suspicious. The behaviour dynamics classified as suspicious may be one of pre-trained suspicious behaviour dynamics or new suspicious behaviour dynamics. The processor-executable instructions, on execution, may further cause the processor to perform, by the 3D ResNet, incremental learning based on the new suspicious behavior dynamics.

In one embodiment, a non-transitory computer-readable medium storing computer-executable instructions for adaptive identification of suspicious activities is disclosed. In one example, the stored instructions, when executed by a processor, may cause the processor to receive image data captured by an image capturing device. The image data includes a plurality of frames. For each frame of the plurality of frame, the operations may further include processing the frame. For processing, the operations may further include detecting, via a deep learning network, one or more individuals in the frame. For processing, the operations may further include estimating, through the deep learning network, a pose of each of the one or more individuals. The operations may further include determining, via the deep learning network, behavior dynamics of the one or more individuals based on the pose estimated in each of the plurality of frames. The behavior dynamics includes at least one of interaction patterns amongst the one or more individuals and an activity pattern of each of the one or more individuals. The operations may further include classifying, via a 3D ResNet, the behavior dynamics as one of suspicious and non-suspicious. The behaviour dynamics classified as suspicious may be one of pre-trained suspicious behaviour dynamics or new suspicious behaviour dynamics. The operations may further include performing, by the 3D ResNet, incremental learning based on the new suspicious behavior dynamics.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for adaptive identification of suspicious activities, in accordance with some embodiments of the present disclosure.

FIG. 2 illustrates a functional block diagram of a memory of a computing device configured to adaptively identify suspicious activities, in accordance with some embodiments of the present disclosure.

FIG. 3 illustrates a flowchart of an exemplary process for adaptive identification of suspicious activities, in accordance with some embodiments of the present disclosure.

FIG. 4 illustrates a flowchart of an exemplary process for determining interaction patterns between people, in accordance with some embodiments of the present disclosure.

FIG. 5 illustrates a flowchart of an exemplary process for determining an activity pattern of each of the one or more individuals, in accordance with some embodiments of the present disclosure.

FIG. 6 illustrates determination of activity pattern of an individual, in accordance with some embodiments of the present disclosure.

FIG. 7 illustrates determination of interaction pattern amongst individuals, in accordance with some embodiments of the present disclosure.

FIGS. 8A, 8B, and 8C illustrate graphs representing accuracy of pose estimation by various models, in accordance with some embodiments of the present disclosure.

FIG. 9 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

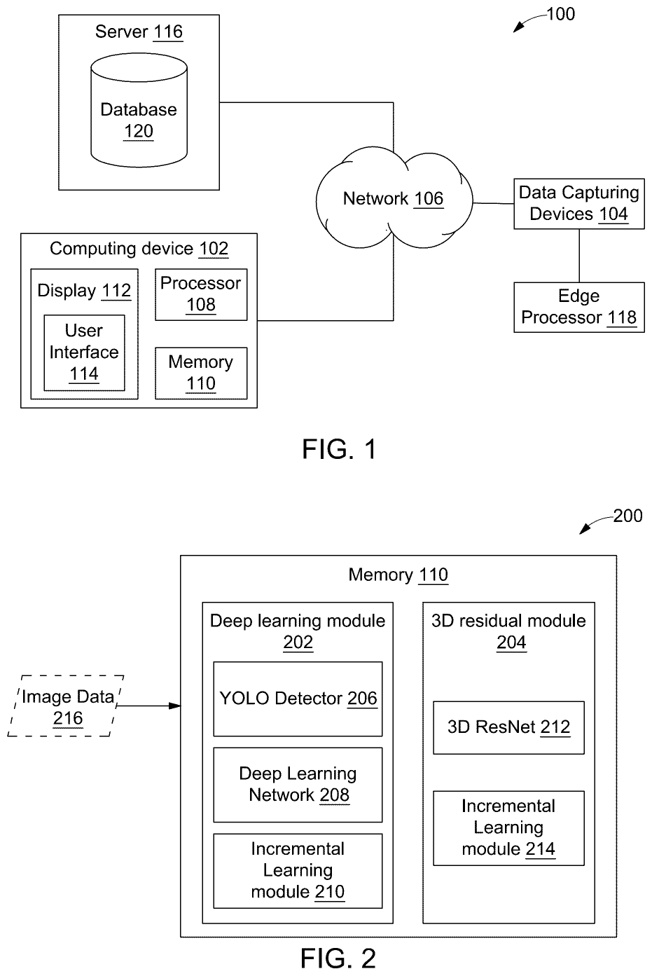

Referring now to FIG. 1, an exemplary system 100 for adaptive identification of suspicious activities is illustrated, in accordance with some embodiments of the present disclosure. Examples of suspicious activities may include, but are not limited to punching, stabbing, shooting, kicking, strangling, pushing, shoving, grabbing, slapping, physically assaulting, or hitting. The system 100 may include a computing device 102 (for example, a server, an edge device, a desktop, a laptop, a notebook, a netbook, a tablet, a smartphone, a mobile phone, or any other computing device). The computing device 102 may identify suspicious activities by analyzing real-time or near real-time data received from data capturing devices 104 via a network 106. The data capturing device 104 may be an edge device in communication with an edge processor 118. Alternatively, the data capturing device 104, which is the edge device, may include the edge processor 118. The data capturing devices 104, for example, may be drones. In this case, the data may include aerial view of a place or an area of interest. The place or the area of interest may be a public area or a controlled environment. The network 106 may correspond to a communication network that may include a communication medium through which the computing device 102 may communicate with other devices or databases. Examples of the communication network may include, but are not limited to, Internet, a cloud network, a Wireless Fidelity (Wi-Fi) network, a Personal Area Network (PAN), a Local Area Network (LAN), or a Metropolitan Area Network (MAN). The computing device 102 may analyze data received from the data capturing devices 104 to identify occurrence of suspicious activities in the given place or area of interest. Subsequently, the computing device 102 may adaptively identify suspicious individuals who are engaged in one or more of the suspicious activities as mentioned above. Suspicious individuals may include a single person or a group of people.

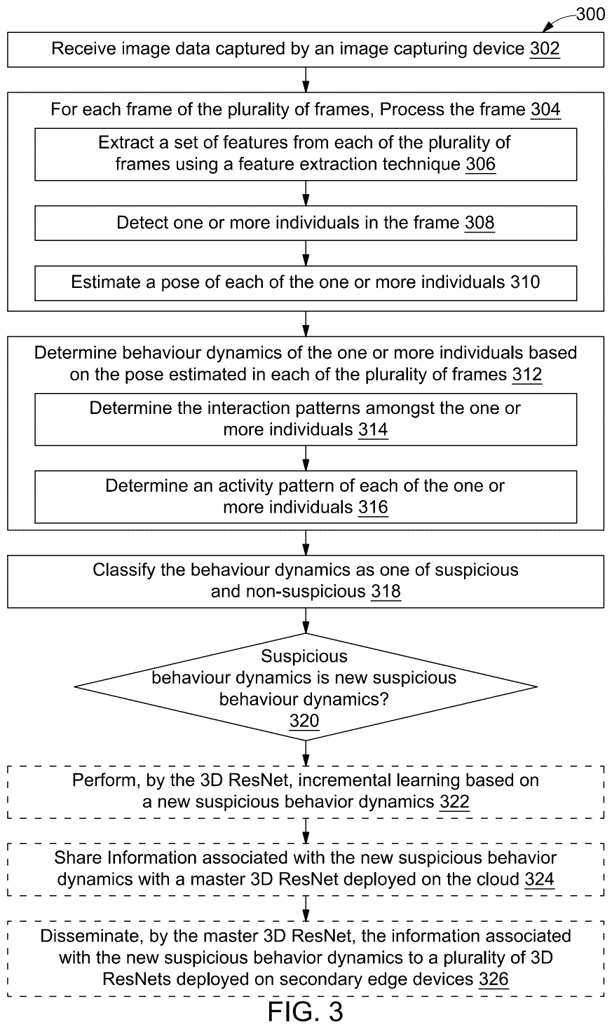

As will be described in greater detail in conjunction with FIGS. 2-9, the data received by the computing device 102 may be image data and the data capturing device 104 may be an image capturing device (e.g., a camera installed on a drone, optical sensor, etc.). As discussed above, the data capturing devices 104 may be drones. By way of an example, a drone may be a Parrot AR Drone. The Parrot AR Drone may include two cameras, an Inertial Measurement Unit (IMU) including a 3-axis accelerometer, 3-axis gyroscope and 3-axis magnetometer, ultrasound and pressure-based altitude sensors, and the like. The two cameras may include a front-facing camera and the downward facing camera. In some embodiments, the front-facing camera may be of a resolution 1280×720 at 30 frames per seconds (fps) with a diagonal field of view of 92° while the downward facing camera may be of the lower resolution of 320×240 at 60 fps with a diagonal field of view of 64°. The fps may vary depending upon the hardware configuration of the system. The front facing camera may record the images due to a higher resolution. The downward facing camera may estimate parameters to determine the state of the drone such as roll, pitch, yaw, and altitude using the sensor onboard to measure a horizontal velocity. The horizontal velocity calculation may be based on an optical flow-based feature. All the sensor measurements are updated at the 200 Hz rate. The selection of a specific drone model is provided to facilitate understanding for the person skilled in the art and is not limiting in any way.

The images captured by the data capturing device 104 may be transferred contemporaneously transferred to a processing system to achieve real-time identification. In some embodiments, the computing device 102 may act as a cloud server that may be used to perform computation in real time. Alternatively, or additionally, the data capturing device 104 may be configured with a processing device for onboard processing. In an embodiment, the data capturing device 104 may be configured to perform constant capturing or recording or may be activated to capture or record based on a specific schedule, or in response to occurrence of an event.

The image data received by the computing device 102 may include a plurality of frames and the computing device 102 may process each of the plurality of frames. To this end, the computing device 102 may use a deep learning network to detect one or more individuals in each of the plurality of frames. Examples of the deep learning network may include, but are not limited to Convolution Neural Networks (CNNs), Recurrent Neural Networks (RNNs), Deep Reinforcement learning, and the like. Thereafter, using the deep learning network, the computing device 102 may estimate a pose of each of the one or more individuals thus detected. Based on the estimated pose, the computing device 102 may further determine, via the deep learning network, behavior dynamics of the one or more individuals. The behavior dynamics may include interaction patterns amongst the one or more individuals. Examples of interaction patterns may include, but are not limited to punching, kicking, and stabbing. Alternatively, or additionally, the behavior dynamics may also include an activity pattern of each of the one or more individuals. The activity pattern may include, but may not be limited to an individual setting fire to an object, aggressive stance (for example, first clenching, positioning oneself in a suspicious way (hiding behind a wall, car, etc.), or the like. The computing device 102 may finally classify, via a 3-dimensional (3D) Residual Network (ResNet), the behaviour dynamics as one of suspicious and non-suspicious. The behaviour dynamics classified as suspicious may be one of pre-trained suspicious behaviour dynamics or new suspicious behaviour dynamics.

The computing device 102 may include one or more processors 108 and a memory 110. Further, the memory 110 may store instructions that, when executed by the one or more processors 108, cause the one or more processors 108 to identify suspicious activities, in accordance with aspects of the present disclosure. The memory 110 may also store various data (for example, image data, a plurality of frames, an activity pattern, an interaction pattern, a set of features and the like) that may be captured, processed, and/or required by the computing device 102. The memory 110 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The computing device 102 may further include a display 112 that may render a user interface 114. A user, or an administrator may interact with the computing device 102 and vice versa through the user interface 114 on the display 112. In some embodiments, the computing device 102 may further communicate with a server 116 via the network 106 for sending and receiving various data (for example, for receiving content corresponding to an event).

Referring now to FIG. 2, a functional block diagram 200 of the memory 110 of the computing device 102 configured to adaptively identify suspicious activities is illustrated, in accordance with some embodiments of the present disclosure. FIG. 2 is explained in conjunction with FIG. 1. The memory 110 may include a deep learning module 202 and a 3-Dimensional (3D) residual module 204. The deep learning module 202 may further include a You Only Detect Once (YOLO) detector 206 and two or more deep learning networks, for example, a deep learning network 208, and an incremental learning module 210. The 3D residual module 204 may include a 3D ResNet 212 and an incremental learning module 214.

The deep learning module 202 may receive image data 216 captured by the data capturing devices 104. As discussed in FIG. 1, the data capturing devices 104 may be configured to capture or record one or more aerial images. The data capturing devices 104 may include image capturing devices fitted on one or more drones as explained in FIG. 1. In some embodiments, the data capturing devices 104 may also be configured to respond to suspicious activities.

As discussed in FIG. 1, the image data 216 may include a plurality of frames. The deep learning module 202 may process each of the plurality of frames. To this end, the deep learning module 202 may extract a set of features from each of the plurality of frames using a feature extraction technique via the deep learning network 208. Examples of the feature extraction technique may include but are not limited to Explicit Semantic Analysis (ESA), Non-Negative Matrix Factorization (NMF), Singular Value Decomposition (SVD), and Principal Component Analysis (PCA). Thereafter, the deep learning module 202 may use the YOLO detector 206 to detect one or more individuals in the frame. The YOLO detector 206 may perform analysis on each frame to extract features from each frame. The YOLO detector 206 may use a single neural network. The single neural network may be applied on the complete image captured by the data capturing device 104. The single neural network may divide the image into regions and predicts bounding boxes and probabilities for each region.

Further, the YOLO detector 206 may resize the detected region to 120×80 pixels and further may normalize the regions by subtracting the image regions mean and dividing by its standard deviation. The bounding boxes may be assigned weights based on the predicted probabilities to detect one or more individuals. In an embodiment, the YOLO detector 206 may be pre-trained on various categories detection dataset. Based on pre-training, the YOLO detector 206 may detect individuals recorded by the data capturing device 104 (for example, drones) with an accuracy of 97.2%.

On detecting the one or more individuals, the deep learning module 202 may estimate a pose of each of the one or more individuals via the deep learning network 208 (for example, a ScatterNet Hybrid Learning (SHDL) network). Based on the pose estimated in each of the plurality of frames, the deep learning module 202 may determine behavior dynamics of the one or more individuals via the deep learning network 208.

In an embodiment, the behavior dynamics may include interaction patterns amongst the one or more individuals. One or more individuals may be present in a group and the interaction patterns may, for example, include interaction of each individual with one or more of the remaining individuals in the group. Alternatively, the interaction patterns may correspond to the interaction pattern of a group of individuals from the remaining group of individuals in the frame. The deep learning module 202 may identify at least one group of individuals from the one or more individuals in each of the plurality of frames via the deep learning network 208. For each of the at least one group of individuals, the deep learning module 202 may compare the pose of each individual of the group with the pose of each of remaining individuals of the group, in each of the plurality of frames via the deep learning network 208. In some embodiments, for each of the at least one group of individuals, the deep learning module 202 may compare a cohesive pose of a first group of individual relative to a cohesive pose of a second group of individuals, in each of the plurality of frames via the deep learning network 208. Based on this, the deep learning module 202 may determine the interaction patterns amongst the one or more individuals of the group based on comparing via the deep learning network 208.

Alternatively, or additionally, the behavior dynamics may also include activity pattern of each of the one or more individuals. One or more individual may be present in a frame. For each individual present in the frame, the activity pattern may correspond to a current activity being performed by the individual. Upon detecting the one or more individuals in the frame by the YOLO detector 206, the deep learning module 202 may estimate a pose of each of the one or more individuals via the deep learning network 208.

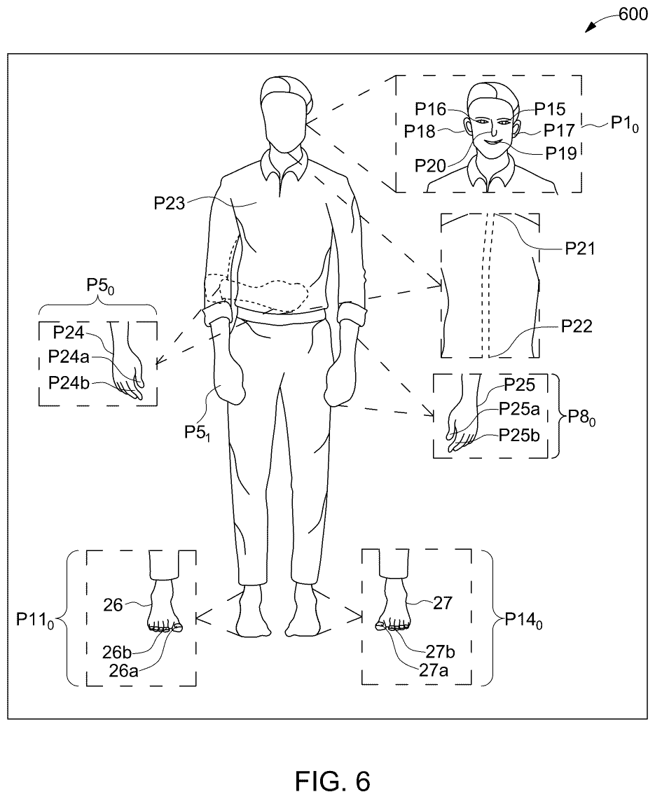

In order to identify a pose of an individual, the deep learning module 202 may identify a plurality of key points of the individual in the frame via the deep learning network 208. Each of the plurality of key points corresponds to a body part of an individual. For example, the fourteen key points may include a facial region, an arm region, a leg region, and a torso region. The facial region may include the key points P10 and P20. While the key point P10 may include a head region, the key point P20 may include a neck region, and the like. These are explained in greater detail in conjunction with FIG. 6. Upon identifying the key points of an individual, the deep learning network 208 may estimate the pose of the individual in the frame based on a position of each of the plurality of key points in the frame.

Thereafter, the deep learning module 202 may iteratively compare the plurality of key points of the individual in a current frame with the plurality of key points of the same individual in a next frame via the deep learning network 208. The current frame may correspond to a first time instance T1, while the next frame may correspond to a second time instance T2 that immediately succeeds the first time instance. It should be noted that the second time instance T2 is greater than the first-time instance T1. This iterative comparison may be continued for a given set of frames spread over a time period. Thus, based on the iterative comparison between consecutive frames, the deep learning network 208 may determine activity pattern of the individual. In a similar manner, activity pattern for a group of individuals may also be determined. The deep learning network 208 may be a hybrid deep learning network based on Regression Network (RN). The hybrid deep learning network based on RN may be an SHDL network. The SHDL network may extract invariant and discriminative image representation for object recognition. The SHDL network may be composed of a ScatterNet front-end and a RN back-end. The ScatterNet (front-end) may be the parametric log based Dual-Tree Complex Wavelet transform (DTCWT) ScatterNet. The DTCWT ScatterNet may be a result of numerous improvements to previous versions of the hand-crafted multi-layer Scattering Networks. The DTCWT ScatterNet front-end may extract the handcrafted features (manually designed domain specific features that may be extracted from images to capture relevant information for a particular task). Examples of handcrafted features may include, but may not be limited to Color Histograms, Corner Detection, Histogram of Oriented Gradients (HOG), Edge Detection. The handcrafted features may be used by the SHDL network to learn hierarchical features that may capture intricate structure between different object classes for classification. The ScatterNet features are denser over scale as they are extracted from multi-resolution image at 1.5 times and twice the size of the input image. Further, the RN back-end may be formed of the modified coarse-to-fine deep RN with the hand-crafted parametric log Scatter-Net. The RN back-end may select the features specific to each object class, from the feature hierarchies. Finally, the selected features specific to each object class may be used for classification. Additionally, the RN may use structural priors to expedite the training as well as reduce the dependence on the annotated datasets.

In some embodiments, the SHDL network may be trained with an Aerial Violent Individual (AVI) Dataset. The AVI dataset may include the images with individuals recorded at different variations of scale, position, illumination, blurriness, etc. The AVI dataset is used by the SHDL network to learn pose estimation. The AVI dataset may be composed of plurality of images. Each image may include at least two individuals. The AVI dataset may also include a plurality of individuals or group of individuals engaged in one or more of the suspicious or violent activities. The suspicious activities may include, but are not limited to punching, stabbing, shooting, kicking, strangling, pushing, shoving, grabbing, slapping, physically assaulting, or hitting. Further, in the AVI dataset each individual in the aerial image frame may be annotated with one or more of the plurality of key points which are utilized by the SHDL network as labels for learning pose estimation. Once the interaction patterns are determined, the 3D residual module 204 may compare the interaction patterns amongst the one or more individuals in a current frame with the interaction patterns amongst the individuals in a previous frame via the 3D ResNet 212. While the previous frame may correspond to a zeroth time instance T0, the current frame may correspond to a first time instance T1. It should be noted that the first time instance T1 immediately succeeds the zeroth time instance T0. In other words, the previous frame and the current frame may be consecutive in the plurality of frames. Further, the 3D Residual module 204 may classify the interaction patterns as one of suspicious or non-suspicious based on the comparing via the 3D ResNet 212. The 3D ResNet 212 may be trained using labeled or unlabeled training data that includes frames with estimated poses for classifying suspicious interaction patterns (such as punching, stabbing, shooting, kicking, and strangling). The behaviour dynamics classified as suspicious is one of pre-trained suspicious behaviour dynamics or new suspicious behaviour dynamics.

By way of an example, a group of students may be practicing karate in an open ground and a drone may capture multiple frames of this activity being performed in the open ground. Based on an analysis of the multiple frames, via the deep learning module 202 as explained above, behavior dynamics for each student in the group may be identified. The behavior dynamics in this case may be the interaction patterns of amongst the group of students. Thereafter, the 3D ResNet 212 may compare the interaction patterns amongst the group of students identified in each consecutive frame from the multiple frames captured by the drone. Based on the comparison, the 3D ResNet 212 may classify the interaction patterns amongst the group of students as non-suspicious, though each of them are performing Karate, which is strongly indicative of violent activity.

By way of another example, the same group of students, subsequent to their karate practice, may get into a fight with a different group of students on the same ground, while using their karate skills. In this case, based on the analysis of the identified interaction patterns, the 3D ResNet 212 may classify the interaction patterns as suspicious activity, though very similar interaction patterns was initially and correctly identified as non-suspicious. Thus, the accuracy of the present system in identifying and differentiating suspicious activities from non-suspicious activities is very high.

In a similar manner, based on the determined activity pattern of an individual, the 3D ResNet 212 may classify the individual as non-suspicious or suspicious. As explained before, the 3D ResNet 212 may be trained using labeled or unlabeled training data that includes image frames with estimated poses for classifying suspicious activity pattern (such as stalking, hiding behind a wall, setting fire to an object, etc.).

By way of an example, a given individual may be performing a solo dance in a crowded area. Based on an analysis of the multiple frames, via the deep learning module 202 as explained above, behavior dynamics for the individual may be identified. The behavior dynamics in this case would be the activity pattern of the individual, i.e., the solo dance performance. Once the activity patterns of the individual is identified based on analysis of consecutive frames spread across a time period,, the 3D ResNet 212 may classify the individual as non-suspicious (based on the individual's activity patterns, i.e., dancing). In continuation of the example given above, the same individual while dancing may be hiding a knife in his pocket and in a subsequent time period may wield the knife with intent of attacking someone. In this case, based on analysis of the activity pattern across consecutive frames in the subsequent time period, the activity pattern of the individual may be identified. Based on the identified activity pattern, the 3D ResNet 212 may now classify the individual as suspicious. It will be apparent that accuracy of the present system in identifying and differentiating a suspicious individual from a non-suspicious individual is very high. A given individual who was initially identified as non-suspicious, is immediately identified as suspicious the moment he wields the knife, irrespective of him still dancing while wielding a knife.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as dedicated hardware circuit comprising custom application-specific integrated circuit (ASIC) or gate arrays, off-the-shelf semiconductors such as logic chips, transistors, or other discrete components. Each of the modules 202-214 may also be implemented in a programmable hardware device such as a field programmable gate array (FPGA), programmable array logic, programmable logic device, and so forth. Alternatively, each of the modules 202-214 may be implemented in software for execution by various types of processors (e.g., processor 108). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

It should be noted that the 3D ResNet 212 may include an adaptive learning or incremental learning capability that may ensure continuous improvement in accuracy for pose estimation and behaviour dynamics determination over time, as the 3D ResNet 212 learns from user-assigned labels (i.e., user feedback), thereby enhancing responsiveness of the 3D ResNet 212 to evolving patterns and trends in data. In some embodiments, the estimated pose and the behaviour dynamics may be retained permanently (in response to estimating the pose and determining the behaviour dynamics, respectively) in the database 120. Further, an incremental learning may be performed by the 3D ResNet 212 based on the estimated pose and the behaviour dynamics. The 3D ResNet 212 may recognize and process significant poses and behaviour dynamics for permanent retention. For example, once a pose and/or behaviour dynamics is later classified as suspicious by user, it needs to be integrated into the database 120 associated with the 3D ResNet 212. Moreover, the 3D ResNet 212 undergoes a retraining process to incorporate information of the estimated pose and the behaviour dynamics without compromising previously acquired knowledge. This retraining ensures that the 3D ResNet 212 continues to evolve and adapt, effectively updating a current understanding while retaining the previously acquired knowledge accumulated over time. Additionally, in some embodiments, the estimated pose and the behaviour dynamics may be retained in a memory of an edge node (for example, the database 120) for a predefined time duration.

Once the behaviour dynamics are classified as new suspicious behaviour dynamics, the incremental learning module 214 may perform incremental learning for the 3D ResNet 212, based on the new suspicious behavior dynamics. The 3D ResNet 212 may be deployed on a primary edge device. To perform the incremental learning, the incremental learning module 214 may share information associated with the new suspicious behavior dynamics with a master 3D ResNet 212 deployed on the cloud. Further, the master 3D ResNet may disseminate the information associated with the new suspicious behavior dynamics to a plurality of 3D ResNets deployed on secondary edge devices. In other words, when a new suspicious behavior is identified, the computing device 102 may employ incremental learning to update its knowledge base, share this information with the master 3D ResNet 212, which would further disseminate the information to all 3D ResNets deployed on secondary edge devices. As a result, all 3D ResNets deployed across the globe would be updated instantly with information related to new suspicious behaviors.

In some embodiments, the incremental learning module 214 may implement a Human-in-the-Loop (HITL) technique to perform the incremental learning. The HITL technique may integrate user inputs (for example, a feedback) corresponding to the new suspicious behaviour dynamics. The incremental learning may selectively train specific neural network layers on the data capturing devices 104 (edge devices), avoiding the need for complete model retraining. The incremental learning ensures that new behaviors are integrated seamlessly without disrupting the recognition of previously learned behaviors. Similarly, the master 3D ResNet may then disseminate the information associated with the new suspicious behavior dynamics to a plurality of deep learning networks deployed on secondary edge devices.

In continuation of the above example, another individual hiding a knife in his pocket in a subsequent time period may wield the knife with an intent of attacking someone. The behaviour dynamics of the individual may be classified as a new suspicious behaviour dynamics by the data capturing device 104 through the edge processor 118. It may be noted that the classification of the new suspicious behaviour dynamics may be performed based on deviations in the plurality of key-points (for example, the fourteen key-points), temporal trajectories, activity pattern or interaction pattern of the individual in the plurality of frames. Further, a primary 3D ResNet deployed on a primary data capturing device may perform incremental learning based on the new suspicious behavior dynamics. The primary 3D ResNet may then share information associated with the new suspicious behavior dynamics with the 3D ResNet 212 (i.e., a master 3D ResNet) deployed on the memory 110 of the computing device 102. In an embodiment, the computing device 102 may be a server hosted on a cloud. Further, the 3D ResNet 212 may disseminate the information associated with the new suspicious behaviour dynamics to a plurality of 3D ResNets deployed on secondary data capturing devices. It may be noted that the primary data capturing device and the secondary data capturing devices may be a part of the data capturing devices 104. The incremental learning may minimize latency and also immediately enable detection of the new suspicious behaviour by the data capturing devices 104. The incremental learning may be beneficial in high-stakes environments, where rapid adaptability is critical.

As will be appreciated by one skilled in the art, a variety of processes may be employed for identification of suspicious activities. For example, the exemplary system 100 and the associated computing device 102, may identify suspicious activities by the processes discussed herein. In particular, as will be appreciated by those of ordinary skill in the art, control logic and/or automated routines for performing the techniques and steps described herein may be implemented by the system 100 and the associated computing device 102, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

Referring now to FIG. 3, an exemplary process 300 for adaptive identification of suspicious activities is depicted via a flowchart, in accordance with some embodiments of the present disclosure. FIG. 3 is explained in conjunction with FIG. 2. The process 300 may be implemented by the computing device 102. The process 300 may include receiving the image data 216 captured by an image capturing device, at step 302. The image data 216 may include a plurality of frames and may be one of thermal image data, Infrared (IR) image data, or visible light image data. Further, for each frame of the plurality of frames, the process 300 may include processing the frame via the deep learning network 208, at step 304.

Processing the frame may include extracting a set of features from each of the plurality of frames using a feature extraction technique via the deep learning network 208, at step 306. Upon extracting the set of features, one or more individuals may be detected in the frame via the deep learning network 208, at step 308. Thereafter, based on detecting, a set of features from each of the plurality of frames may be estimated using a feature extraction technique via the deep learning network 208, at step 310.

Further, the process 300 may include determining behavior dynamics of the one or more individuals based on the pose estimated in each of the plurality of frames via the deep learning network 208, at step 312. For determining the behavior dynamics, interaction patterns amongst the one or more individuals may be determined via the deep learning network 208, at step 314. Alternatively, or additionally, an activity pattern of each of the one or more individuals may be determined via the deep learning network 208, at step 316.

On determining the behavior dynamics, the process 300 may classify the behaviour dynamics as one of suspicious and non-suspicious via the 3D ResNet 212, at step 318. Once the behaviour dynamics are classified as suspicious behaviour dynamics, the process 300 may further include checking if the suspicious behaviour dynamics is pre-trained suspicious behaviour dynamics or new suspicious behaviour dynamics, at step 320. If the suspicious behaviour dynamics is the new suspicious behaviour dynamics, the process 300 may further perform, for the 3D ResNet 212, incremental learning based on the new suspicious behaviour dynamics, at step 322. It may be noted that the 3D ResNet 212 may be deployed on a primary edge device. The process 300 may share information associated with the new suspicious behaviour dynamics with a master 3D ResNet deployed on the cloud, at step 324. The process 300 may disseminate, via the master 3D ResNet, the information associated with the new suspicious behaviour dynamics to a plurality of 3D ResNets deployed on secondary edge devices, at step 326.

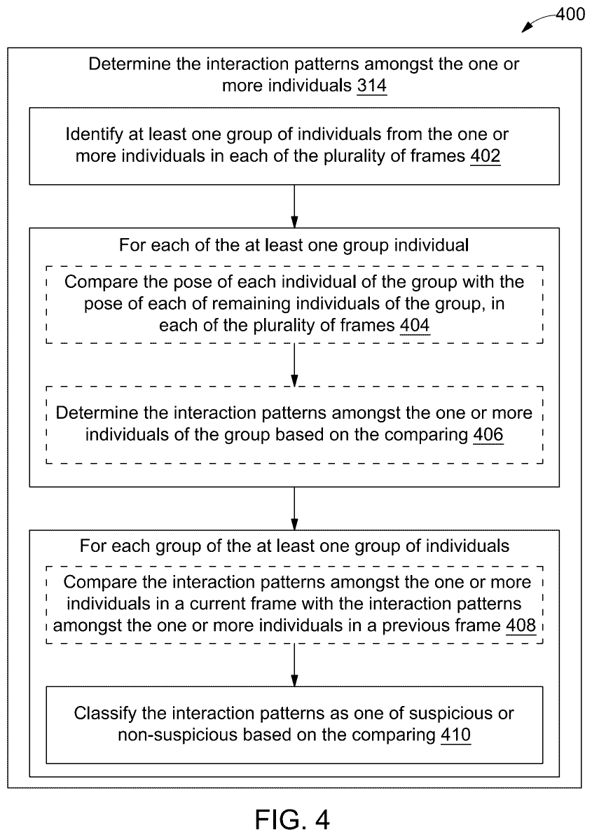

Referring now to FIG. 4, an exemplary process 400 for determining the interaction patterns amongst individuals is depicted, in accordance with some embodiments of the present disclosure. FIG. 4 is explained in conjunction with FIGS. 2, and 3. The process 400 may be implemented by the computing device 102. Determining at least one of interaction patterns amongst the one or more individuals via the deep learning network 208 may include steps 402-410 as explained below.

At step 402, at least one group of individuals from the one or more individuals in each of the plurality of frames may be identified via the YOLO detector 206, at step 402.

For each group of the at least one group of individuals, the pose of each individual of the group may be compared with the pose of each of remaining individuals of the group, in each of the plurality of frames via the deep learning network 208, at step 404. Additionally, for each group of the at least one group of individuals, the interaction patterns amongst the one or more individuals of the group may be determined based on the comparing via the deep learning network 208, at step 406.

Further, for each group of the at least one group of individuals, the interaction patterns amongst the one or more individuals in a current frame may be compared with the interaction patterns amongst the one or more individuals in a previous frame, via the 3D ResNet 212, at step 408. Additionally, for each group of the at least one group of individuals, the interaction patterns may be classified as one of suspicious or non-suspicious based on the comparing, via the 3D ResNet 212, at step 410.

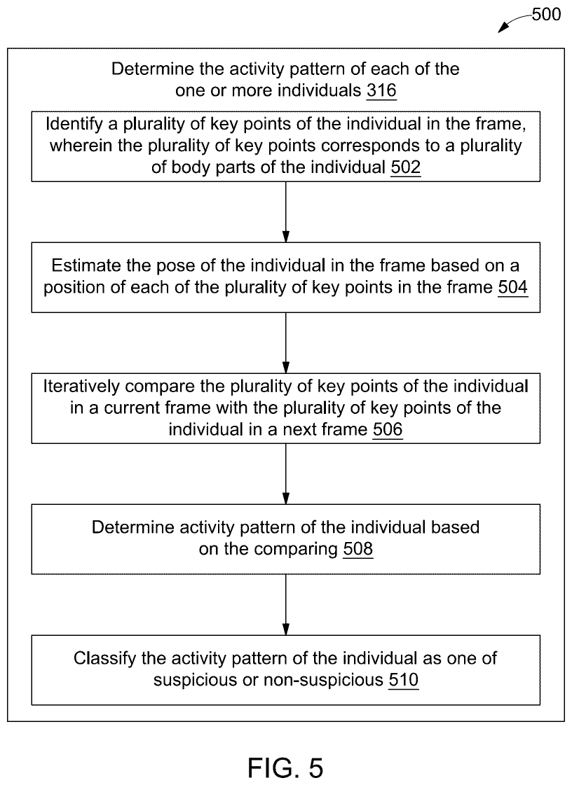

Referring now to FIG. 5, an exemplary process 500 for determining an activity pattern of one or more individuals is depicted, in accordance with some embodiments of the present disclosure. FIG. 5 is explained in conjunction with FIGS. 2 and 3. The process 500 may be implemented by the computing device 102. Determining the activity pattern of each of the one or more individuals via the deep learning network 208 may include steps 502-510.

At step 502, a plurality of key points of the individual in the frame may be identified via the deep learning network 208. The plurality of key points corresponds to a plurality of body parts of the individual. Upon identifying the plurality of key points of the individual, the pose of the individual in the frame may be estimated based on a position of each of the plurality of key points in the frame via the deep learning network 208, at step 504.

Thereafter, the plurality of key points of the individual in a current frame may be iteratively compared with the plurality of key points of the individuals in a next frame by the deep learning network 208, at step 506. The plurality of frames includes the current frame and the next frame. Thereafter, activity pattern of the individual may be determined based on the comparing through the deep learning network 208, at step 508. The activity pattern of the individual may be classified as one of suspicious and non-suspicious via the 3D ResNet 212, at step 510.

Referring now to FIG. 6, determination of activity pattern of an individual is illustrated by a schematic diagram 600, in accordance with some exemplary embodiments of the present disclosure. FIG. 6 is explained in conjunction with FIG. 2-FIG. 5. To begin with, the deep learning module 202 may identify a plurality of key points of the individual in the frame via the deep learning network 208. Each of the plurality of key points corresponds to one or more body parts of the individual. In some embodiments, as described in FIG. 2, the plurality of key points is annotated in a human body. The human body may include a facial region, a left arm region, a right arm region, a left leg region, a right leg region and a torso region. The facial region may include the key points P1₀ and P2₀. The key point P1₀ may correspond to a head region. The key point P2₀ may correspond to a neck region. The left arm region may include key points P3₀, P4₀, and P5₀. The key point P3₀ may correspond to a left shoulder, the key point P4₀ may correspond to a left elbow, the key point P5₀ may correspond to a left wrist. Similarly, the right arm region may include key points P6₀, P7₀, and P8₀. The key point P6₀ may correspond to a right shoulder, the key point P7₀ may correspond to a right elbow, and the key point P8₀ may correspond to a right wrist. Further, the left leg region may include key points P9₀, P10₀, and P11₀. The key point P9₀ may correspond to a left hip, the key point P10₀ may correspond to a left knee, the key point P11₀ may correspond to a left ankle. Similarly, the right leg may include the key points P12₀, P13₀, and P14₀. The key point P12₀ may correspond to a left hip, the key point P13₀ may correspond to a left knee, and the key point P14₀ may correspond to a left ankle.

In the current exemplary embodiment, at first time instance T1, body of the individual may be identified by the key points P1₀, P2₀, P3₀, P4₀, P5₀, P6₀, P7₀, P8₀, P9₀, P10₀, P11₀, P12₀, P13₀, P14₀. Upon identifying the key points, the deep learning module 202 may estimate the pose of the individual in the frame based on a position of each of the plurality of key points in that frame via the deep learning network 208. As depicted, at the first-time instance T1, the key point P5₀ i.e., the left hand may be behind the back of the individual. In other words, the individual may be hiding his left hand. Similarly, at second time instance T2, the individual may be detected through the key points P1₀, P2₀, P3₀, P4₀, P5₁, P6₀, P7₀, P8₀, P9₀, P10₀, P11₀, P12₀, P13₀, and P14₀. In other words, other than the left hand (represented by the key point P5₁), other body parts may have retained their original position at the second time instance T2 as well. The key point P5₁, i.e., the left hand may be holding a weapon and may be clearly visible at the second time instance T2.

In order to determine an activity pattern of the individual, the deep learning module 202 may iteratively compare the plurality of key points at the first-time instance T1 and the second-time instance T2 via the deep learning network 208. Based on the comparison, the deep learning module 202 may determine the activity pattern. Finally, based on the activity pattern, the 3D residual module 204 may determine that the activity pattern corresponds to a suspicious activity (i.e., a threatening stance with a weapon) via the 3D ResNet 212. Accordingly, the 3D residual module 204 may classify the individual as a suspicious individual via the 3D ResNet 212.

In an embodiment, the head region i.e., P1₀ may further include key points P15₀, P16₀, P17₀, P18₀, P19₀ and P20₀. The key point P15₀ may correspond to a right eye, the key point P16₀ may correspond to a left eye, the key point P17₀ may correspond to a right ear, the key point P18₀ may correspond to a left ear, the key point P19₀ may correspond to a nose, and the key point P20₀ may correspond to a mouth. Further, the mouth, i.e., P20₀ may be further broken down into plurality of key points (for example teeth, tongue, etc.).

Further, the torso region may include key points P21₀, P22₀, and P23₀. The key point P21₀ may correspond to an upper spine, the key point P22₀ may correspond to a lower spine, and the key point P23₀ may correspond to a chest. The key point P24₀ may correspond to a left-hand region. The left-hand region i.e., P24₀ may further include key points P24a, P24b, and the like. The key point P24a may correspond to a left thumb, the key point P24b may correspond to a left Index, and so on. In a similar manner, the key point P25₀ may include a right-hand region. The right-hand region i.e., P25₀ may include key points P25a, P25b, and the like. The key point P25a may correspond to a right thumb, the key point P25b may correspond to a right index, and so on.

The key point P26₀ may include a left-leg region. The left-leg region may further include key points P26a, P26b, and so on. The key point P26a may correspond to a left big toe, the key point 26b may correspond to a left second toe, and so on. Similarly, the key point P27₀ may include a right-leg region. The right-leg region P27₀ may include key points P27a, P27b, and so on. The key point P27a may correspond to a right big toe, the key point 27b may correspond to a right second toe, and so on. In some embodiment, the plurality of key points may provide a more refined understanding of a body posture, movement of the individual, and gestures especially in complex activities or expressive behaviors.

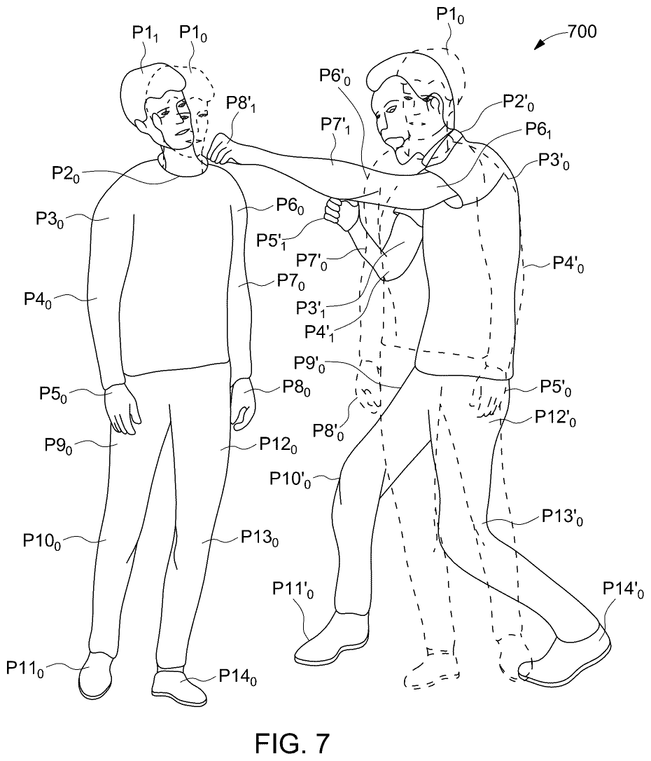

Referring now to FIG. 7, determination of interaction patterns between two individuals is illustrated by a schematic diagram 700, in accordance with some exemplary embodiments of the present disclosure. FIG. 7 is explained in conjunction with FIG. 2-FIG. 5. To determine the interaction pattern amongst individuals, the deep learning module 202 may identify at least one group of individuals from these individuals in each of the plurality of frames via the deep learning network 208. In the current exemplary embodiment, two individuals, i.e., a first individual and a second individual, may be initially identified.

At time instance T0, the first individual may be detected through the key points P1₀, P2₀, P3₀, P4₀, P5₀, P6₀, P7₀, P8₀, P9₀, P10₀, P11₀, P12₀, P13₀, and P14₀. The key points and corresponding body parts are explained in greater detail in conjunction with FIG. 6. Similarly, at the time instance T0, the second individual may be detected through the key points P1′₀, P2′₀, P3′₀, P4′₀, P5′₀, P6′₀, P7′₀, P8′₀, P9′₀, P10′₀, P11′₀, P12′₀, P13′₀, and P14′₀. Further, the deep learning module 202 may compare the pose of the first individual with the pose of the second individual via the deep learning network 208. It may be noted that the first individual and the second individual at the time instance T0 are in a normal state.

Further, at time instance T1, the first individual may be detected through the key points P1₁, P2₀, P3₀, P4₀, P5₀, P6₀, P7₀, P8₀, P9₀, P10₀, P11₀, P12₀, P13₀, and P14₀. It will be apparent that only key points P11 has deviated when compared with their respective positions the time instance T0. Based on an iterative comparison of the plurality of key points of the first individual at the time instance T0 with the plurality of key points at the time instance T1, the deep learning network 208 may determine that only the key point P1₁ has deviated from the normal state. Since the key point P1₁ represents the head region. It may thus be derived, based on the comparison, that the head of the first individual has moved. It may further be determined that since the head region has moved across two consecutive time instances, which may be a fraction of a second, the movement may be a response to an external force or natural stimulus of the first individual. Similarly, at the time instance T1, the second individual may be detected through the key points P1′₀, P2′₀, P3′₁, P4′₁, P5′₁, P6′₁, P7′₁, P8′₁, P9′₀, P10′₀, P11′₀, P12′₀, P13′₀, and P14′o. It will be apparent that only key points P3′₁, P4′₁, P5′₁, P6′₁, P7′₁, P8′₁ have deviated when compared with their respective positions the time instance T0. While the key points P3′₁, P4′₁, P5′₁, represent the left-hand region, the key points P6′₁, P7′₁, P8′₁ the right-hand region. Based on an iterative comparison of the plurality of key points of the second individual at the time instance T0 with the plurality of key points at the time instance T1, the deep learning network 208 may determine that both the hands of the second individual have moved by a considerable degree from the normal state within the two consecutive time instances. It may thus be derived, based on the comparison, that the second individual is performing some prompt action using his hands.

The deep learning module 202 may further compare the pose transitions of the first individual with the pose transitions of the second individual via the deep learning network 208 across the time instance T0 and the time instance T1. In other words, the deep learning module 202 may iteratively compare the plurality of key points of the first individual in a current frame and the next frame with the plurality of key points of the second individual in the current frame and the next frame respectively to determine an interaction patterns between the first and the second individual across the time instances T0 and T1. Further, the 3D ResNet 212 may compare the interaction patterns between the first individual and the second individual to classify the interaction patterns as suspicious activity and the second individual as a suspicious person. In continuation of the example above, the 3D ResNet 212 may determine that the second individual is in an aggressive stance and in response the first individual is in a defensive stance. Thus, the interaction patterns are classified as suspicious.

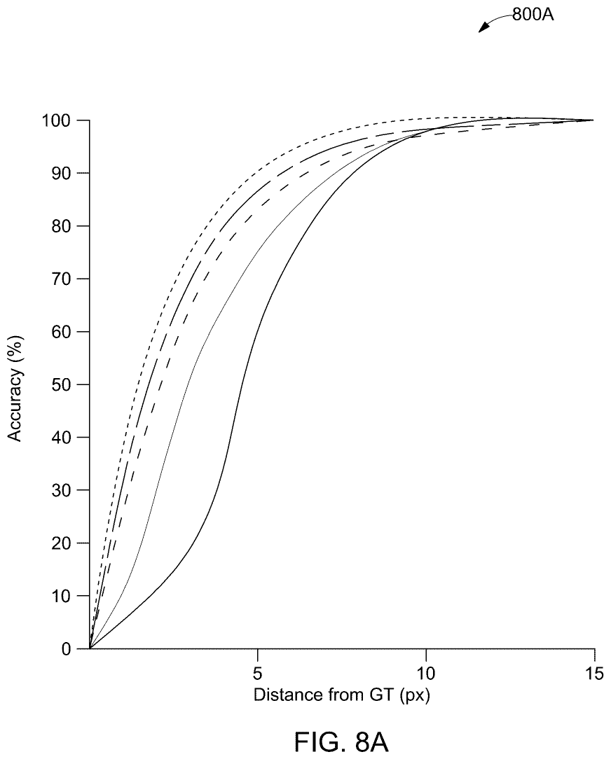

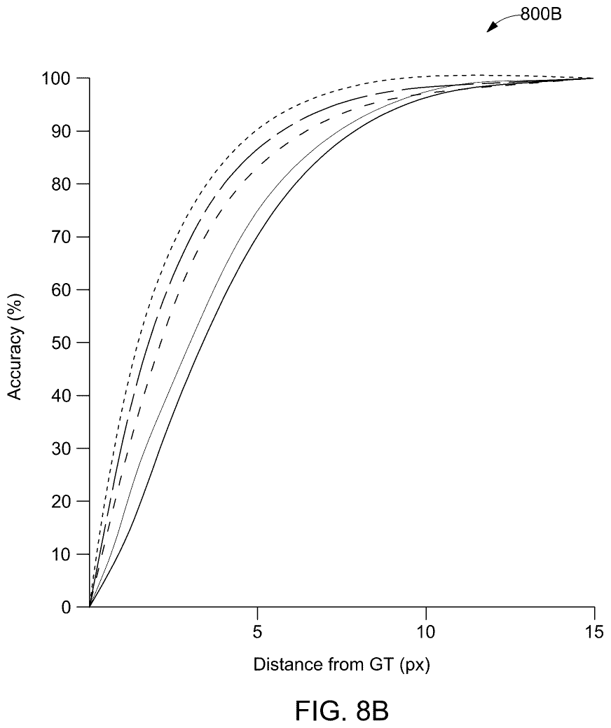

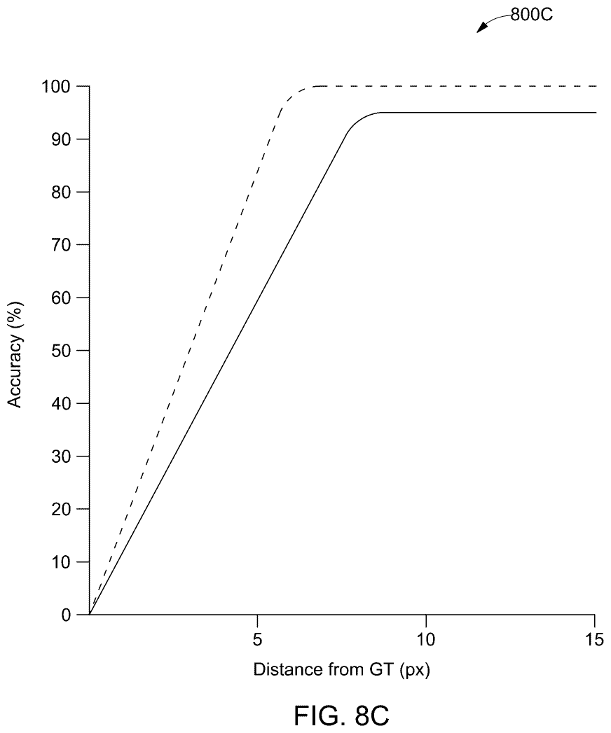

Referring now to FIGS. 8A, 8B, and 8C, graphs representing accuracy of pose estimation by various models are illustrated, in accordance with some embodiments of the present disclosure. X-axis of the graphs represent the values of distance from Ground Truth (GT). The GT may refer to the accurate and verified data which is used to train deep learning network 208. Y-axis of the graphs represent the accuracy in percentage. The FIGS. 8A, 8B, and 8C may include evaluating the pose estimation performance of the SHDL network. Evaluating the pose estimation may include comparing the coordinates of the detected key points (for example, 14 key points) with GT values on the annotated dataset. The key points may be deemed correctly located if the key points are within a set distance of pixels (pixel distance (d)) from a marked key point in the GT via the representing accuracy of pose estimation by various models' graph, for different regions of the human body.

In an embodiment, the arms region may include wrist key points (P5₀ and P8₀), shoulder key-points (P3₀ and P6₀), and elbow key points (P4₀ and P7₀) as illustrated in FIG. 6. In FIG. 8A, a graph 800A may indicate the accuracy of detection of the wrist region by the SHDL network (for example, the SHDL network 208). The SHDL network may detect the wrist region with an accuracy of 60% for a pixel distance d=5. The detection accuracy is much higher for the elbow region and the shoulder region at roughly 85% and 95% respectively, for the same pixel distance d=5. In another embodiment, the leg region may include hip key points (P9₀ and P12₀), knee key points (P10₀ and P13₀), and ankle key-points (P11₀ and P14₀), as illustrated in FIG. 6. In FIG. 8B, a graph 800B indicates detection of hip key points by the deep learning module 202 with almost 100% accuracy for pixel distance of d=5. The detection accuracy is between 85% and 90% for the knee key-points while the detection rate falls around 85% for the ankle key points.

In another embodiment, the facial region may include two key points, one the head (P1₀) and the other the neck (P2₀) as illustrated in FIG. 6. In FIG. 8C, a graph 800C indicates detection of the neck region by the deep neural network 202 more accurately as compared to the head key-point with an accuracy of around 95% as opposed to roughly 77% accuracy, for a pixel distance of d=5.

Table 1 illustrates the comparison of pose estimation of an individual by SHDL network (for example, the SHDL network 208) with Coordination Network (CN), Coordination Extended Network (CNE), and Spatial Network. The comparison may be based on the detection of the plurality of key points of an individual. The evaluation may be presented on the AVI dataset. The pixel distance (d) allowed is 5 from the Ground Truth (GT).

TABLE 1
Comparison of the human pose estimation performance of
SHDL network with Coordinate network (CN), Coordinate
extended network (CNE) and Spatial network.

| | Deep Learning Networks | | | |
|---|---|---|---|---|
| Dataset | SHDL | CN | CNE | Spatial Network |
| AVI | 87.6 | 79.6 | 80.1 | 83.4 |

As observed from the table, the SHDL network may estimate the pose of the individual based on the plurality of key points (for example, 14 key-points) at pixel distance d=5 from the GT, with 87.6% accuracy. Further, the human pose estimation performance of the SHDL network is also compared with several state-of-the art pose estimation methods. The proposed SHDL network outperforms the present state of art by a decent margin.

In another exemplary embodiment, the estimated pose may be given as input to the 3D ResNet 212 for classification of the individual as suspicious or non-suspicious. Table 2 illustrates the classification accuracy (%) for the suspicious activities on the AVI dataset. The suspicious activity dataset may include punching, kicking, strangling, shooting, stabbing. The classification accuracy on the AVI dataset of each suspicious activity may be presented for 4224 (40%) human poses as shown in Table 2.

TABLE 2
Table presents the classification accuracy (%) for the suspicious
activities on Aerial Violent Individual (AVI) dataset.

| | Suspicious activities | | | | |
|---|---|---|---|---|---|
| Dataset | Punching | Kicking | Strangling | Shooting | Stabbing |
| DSS | 89 | 94 | 85 | 82 | 92 |

Table 3 illustrates the classification accuracies (%) with the increase in individuals engaged in the suspicious activities in the aerial images of the AVI dataset. The dataset may include number of violent individuals (per image).

TABLE 3
The table presents the classification accuracies (%) with the increase
in individuals engaged in the suspicious activities in the aerial
images.

| | No. of Violent Individuals (Per Image) | | | | |
|---|---|---|---|---|---|
| Dataset | 1 | 2 | 3 | 4 | 5 |
| | 94.1 | 90.6 | 88.3 | 87.8 | 84.0 |

The results in the table 1, table 2, and table 3 may be encouraging as the system 100 may encounter multiple people in an image frame. The classification performance is also compared with the present state of the art. The present state of art techniques was developed to recognize the person of interest from aerial images further illustrated in table 4. The proposed technique may be able to outperform the method by more than 105 on the AVI dataset.

TABLE 4
The table shows the comparison of the suspicious or
violent individual identification performance of the
system 100 with the prior art technique.

| | Comparison | |
|---|---|---|
| Dataset | System 100 | Prior arts |
| AVI | 88.8 | 77.8 |

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

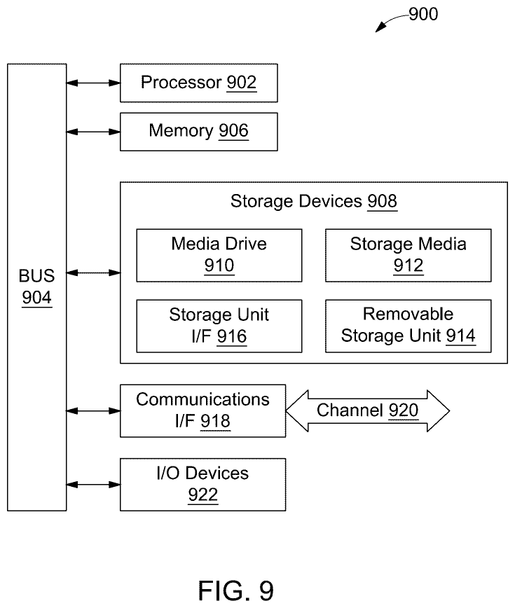

The disclosed methods and systems may be implemented on a conventional or a general-purpose computer system, such as a personal computer (PC) or server computer. Referring now to FIG. 9, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 900 may include one or more processors, such as a processor 902 that may be implemented using a general or special purpose processing engine such as, for example, a microprocessor, microcontroller or other control logic. In this example, the processor 902 is connected to a bus 904 or other communication medium. In some embodiments, the processor 902 may be an Artificial Intelligence (AI) processor, which may be implemented as a Tensor Processing Unit (TPU), or a graphical processor unit, or a custom programmable solution Field-Programmable Gate Array (FPGA).

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during execution of instructions to be executed by the processor 902. The computing system 900 may likewise include a read only memory (“ROM”) or other static storage device coupled to bus 904 for storing static information and instructions for the processor 902.

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during execution of instructions to be executed by the processor 902. The computing system 900 may likewise include a read only memory (“ROM”) or other static storage device coupled to bus 904 for storing static information and instructions for the processor 902.

The computing system 900 may also include a storage devices 908, which may include, for example, a media drive 910 and a removable storage interface. The media drive 910 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 912 may include, for example, a hard disk, magnetic tape, flash drive, or other fixed or removable medium that is read by and written to by the media drive 910. As these examples illustrate, the storage media 912 may include a computer-readable storage medium having stored therein particular computer software or data.

In alternative embodiments, the storage devices 908 may include other similar instrumentalities for allowing computer programs or other instructions or data to be loaded into the computing system 900. Such instrumentalities may include, for example, a removable storage unit 914 and a storage unit interface 916, such as a program cartridge and cartridge interface, a removable memory (for example, a flash memory or other removable memory module) and memory slot, and other removable storage units and interfaces that allow software and data to be transferred from the removable storage unit 914 to the computing system 900.

The computing system 900 may also include a communications interface 918. The communications interface 918 may be used to allow software and data to be transferred between the computing system 900 and external devices. Examples of the communications interface 918 may include a network interface (such as an Ethernet or other NIC card), a communications port (such as for example, a USB port, a micro USB port), Near field Communication (NFC), etc. Software and data transferred via the communications interface 918 are in the form of signals which may be electronic, electromagnetic, optical, or other signals capable of being received by the communications interface 918. These signals are provided to the communications interface 918 via a channel 920. The channel 920 may carry signals and may be implemented using a wireless medium, wire or cable, fiber optics, or other communications medium. Some examples of the channel 920 may include a phone line, a cellular phone link, an RF link, a Bluetooth link, a network interface, a local or wide area network, and other communications channels.

The computing system 900 may further include Input/Output (I/O) devices 922. Examples may include, but are not limited to a display, keypad, microphone, audio speakers, vibrating motor, LED lights, etc. The I/O devices 922 may receive input from a user and also display an output of the computation performed by the processor 902. In this document, the terms “computer program product” and “computer-readable medium” may be used generally to refer to media such as, for example, the memory 906, the storage devices 908, the removable storage unit 914, or signal(s) on the channel 920. These and other forms of computer-readable media may be involved in providing one or more sequences of one or more instructions to the processor 902 for execution. Such instructions, generally referred to as “computer program code” (which may be grouped in the form of computer programs or other groupings), when executed, enable the computing system 900 to perform features or functions of embodiments of the present invention.

In an embodiment where the elements are implemented using software, the software may be stored in a computer-readable medium and loaded into the computing system 900 using, for example, the removable storage unit 914, the media drive 910 or the communications interface 918. The control logic (in this example, software instructions or computer program code), when executed by the processor 902, causes the processor 902 to perform the functions of the invention as described herein.

Thus, the disclosed method and system try to overcome the technical problem of adaptive identification of suspicious activities. The disclosed method and system may receive image data captured by an image capturing device. The image data may include a plurality of frames. Further, for each frame of the plurality of frames, the disclosed method and system may process the frame. Further, for processing, the method and system may detect, via a deep learning network, one or more individuals in the frame. Further, for processing, the method and system may estimate, through the deep learning network, a pose of each of the one or more individuals. Moreover, the disclosed method and system may determine, via the deep learning network, behavior dynamics of the one or more individuals based on the pose estimated in each of the plurality of frames. The behavior dynamics includes at least one of interaction patterns amongst the one or more individuals and an activity pattern of each of the one or more individuals. Thereafter, the disclosed method and system may classify, via a 3D ResNet 212, the behaviour dynamics as one of suspicious and non-suspicious.

As will be appreciated by those skilled in the art, the techniques described in the various embodiments discussed above are not routine, or conventional, or well understood in the art. The techniques may provide a system that boasts the ability to rapidly assimilate meaningful representations even from the limited labeled datasets. Further, the techniques may provide a hybrid nature that may provide flexibility to craft highly optimized structures, enhancing computationally efficiency. The computational efficiency and economic framework may be ideally suited for deployment on edge devices, operating in real time. Additionally, the techniques may be exceptionally advantageous for our specific application, ensuring both performance and practicality.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for identification of suspicious activities. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for adaptive identification of suspicious activities, the method comprising:
receiving image data captured by an image capturing device, wherein the image data comprises a plurality of frames;
for each frame of the plurality of frames, processing the frame, wherein processing comprises:
detecting, via a deep learning network, one or more individuals in the frame; and
estimating, through the deep learning network, a pose of each of the one or more individuals;
determining, via the deep learning network, behaviour dynamics of the one or more individuals based on the pose estimated in each of the plurality of frames, wherein the behaviour dynamics comprise at least one of:
interaction patterns amongst the one or more individuals; and
an activity pattern of each of the one or more individuals; and
classifying, via a 3-dimensional (3D) Residual Network (ResNet), the behaviour dynamics as one of suspicious and non-suspicious.

2. The method of claim 1, wherein the image data is one of thermal image data, Infrared (IR) image data, or visible light image data.

3. The method of claim 1, wherein processing further comprises extracting, via the deep learning network, a set of features from each of the plurality of frames using a feature extraction technique.

4. The method of claim 1, wherein the deep learning network is a hybrid deep learning network based on regression network.

5. The method of claim 1, further comprising identifying, via the deep learning network, at least one group of individuals from the one or more individuals in each of the plurality of frames.

6. The method of claim 5, wherein determining the interaction patterns comprises:
for each group of the at least one group of individuals,
comparing, via the deep learning network, the pose of each individual of the group with the pose of each of remaining individuals of the group, in each of the plurality of frames; and
determining, via the deep learning network, the interaction patterns amongst the one or more individuals of the group based on the comparing.

7. The method of claim 5, further comprising:
for each group of the at least one group of individuals,
for each of the plurality of frames, comparing, via the 3D ResNet, the interaction patterns amongst the one or more individuals in a current frame with the interaction patterns amongst the one or more individuals in a previous frame; and
classifying, via the 3D ResNet, the interaction patterns as one of suspicious or non-suspicious based on the comparing.

8. The method of claim 1, wherein estimating, through the deep learning network, a pose of an individual from the one or more individuals comprises:
identifying, via the deep learning network, a plurality of key points of the individual in the frame, wherein the plurality of key points corresponds to a plurality of body parts of the individual; and
estimating, via the deep learning network, the pose of the individual in the frame based on a position of each of the plurality of key points in the frame.

9. The method of claim 8, further comprising:
iteratively comparing, by the deep learning network, the plurality of key points of the individual in a current frame with the plurality of key points of the individual in a next frame, wherein the plurality of frames comprises the current frame and the next frame; and
determining, through the deep learning network, activity pattern of the individual based on the comparing.

10. The method of claim 1, wherein the behaviour dynamics classified as suspicious is one of pre-trained suspicious behaviour dynamics or new suspicious behaviour dynamics.

11. The method of claim 10, further comprising performing, by the 3D ResNet, incremental learning based on the new suspicious behavior dynamics.

12. The method of claim 11, wherein the 3D ResNet is deployed on a primary edge device.

13. The method of claim 12, wherein performing the incremental learning comprises:
sharing information associated with the new suspicious behavior dynamics with a master 3D ResNet deployed on a cloud; and
disseminating, by the master 3D ResNet, the information associated with the new suspicious behavior dynamics to a plurality of 3D ResNets deployed on secondary edge devices.

14. A system for adaptive identification of suspicious activities, the system comprising:
a processor; and
a memory communicatively coupled to the processor, wherein the memory stores processor instructions, which when executed by the processor, cause the processor to:
receive image data captured by an image capturing device, wherein the image data comprises a plurality of frames;
for each frame of the plurality of frames, process the frame, wherein to process, the processor instructions, on execution, further cause the processor to:
detect, via a deep learning network, one or more individuals in the frame; and
estimate, through the deep learning network, a pose of each of the one or more individuals
determine, via the deep learning network, behaviour dynamics of the one or more individuals based on the pose estimated in each of the plurality of frames, wherein the behaviour dynamics comprise at least one of:
interaction patterns amongst the one or more individuals; and
an activity pattern of each of the one or more individuals; and
classify, via a 3D ResNet, the behaviour dynamics as one of suspicious and non-suspicious.

15. The system of claim 14, wherein the image data is one of thermal image data, Infrared (IR) image data, or visible light image data.

16. The system of claim 14, wherein to process, the processor instructions, on execution, further cause the processor to extract, via the deep learning network, a set of features from each of the plurality of frames using a feature extraction technique.

17. The system of claim 14, wherein the deep learning network is a hybrid deep learning network based on regression network.

18. The system of claim 14, wherein the processor instructions, on execution, further cause the processor to identify, via the deep learning network, at least one group of individuals from the one or more individuals in each of the plurality of frames.

19. The system of claim 18, wherein to determine the interaction patterns, the processor instructions, on execution, further cause the processor to:
for each group of the at least one group of individuals,
compare, via the deep learning network, the pose of each individual of the group with the pose of each of remaining individuals of the group, in each of the plurality of frames; and
determine, via the deep learning network, the interaction patterns amongst the one or more individuals of the group based on the comparing.

20. A non-transitory computer-readable medium storing computer-executable instructions for adaptive identification of suspicious activities, the computer-executable instructions configured for:
receiving image data captured by an image capturing device, wherein the image data comprises a plurality of frames;
for each frame of the plurality of frames, processing the frame, wherein for processing, the computer-executable instructions are further configured for:
detecting, via a deep learning network, one or more individuals in the frame; and
estimating, through the deep learning network, a pose of each of the one or more individuals;
determining, via the deep learning network, behaviour dynamics if the one or more individuals based on the pose estimated in each of the plurality of frames, wherein the behaviour dynamics comprise at least one of:
interaction patterns amongst the one or more individuals; and
an activity pattern of each of the one or more individuals; and
classifying the behaviour dynamics as one of suspicious and non-suspicious.
